(19) United States
(12) Patent Application Publication
(10) Pub. No.: US 2014/0186086 A1
(43) Pub. Date: Jul. 3, 2014

(54) ROLL MEDIUM SUPPORTING DEVICE AND RECORDING APPARATUS

(71) Applicant: Seiko Epson Corporation, Tokyo (JP)

(72) Inventor: Keiichi Yato, Shiojiri-shi (JP)

(73) Assignee: SEIKO EPSON CORPORATION, Tokyo (JP)

(21) Appl. No.: 14/132,640

(22) Filed: Dec. 18, 2013

(30) Foreign Application Priority Data
Dec. 27, 2012 (JP) 2012-284511

(51) Int. Cl. B41J 15/04

(52) U.S. Cl. CPC B41J 15/04
USPC 400/611

(57) ABSTRACT

The roll paper supporting device includes a shaft member that is inserted into a roll paper along an axis of the roll paper; and a flange that includes an insertion hole that allows the shaft member to be inserted and an engagement section engageable with the shaft member, the flange being configured to support the roll paper in an axis direction of the shaft member. The shaft member includes, in a state that the shaft member is inserted into the insertion hole, a fourth engagement groove and a sixth engagement groove that position the flange in the axis direction by engaging the engagement section, and a fifth engagement groove that positions the flange in the axis direction by engaging the engagement section at a position different from the fourth engagement groove and the sixth engagement groove both in the axis direction and in a circumferential direction of the shaft member.

### BACKGROUND

1. Technical Field

The present invention relates to a roll medium supporting device that supports a roll medium such as a roll paper which is made of a long continuous sheet wound into a roll and a recording apparatus having the roll medium supporting device.

2. Related Art

As described in JP-A-2007-8624, a printer is generally known as a recording apparatus that performs recording operation on a roll medium which is made of a long medium wound into a roll. In such a printer, printing operation (recording operation) is performed by a printing section (recording section) on a sheet of paper which is fed while being unwound from a paper roll (roll medium) supported by a reel for paper roll (roll medium supporting device).

The reel for paper roll includes a shaft (shaft member) that is inserted into a core of the paper roll and a pair of regulation members (supporting members) that is mounted on the shaft so as to hold the paper roll from both sides and regulate the movement of the paper roll in the axis direction. A plurality of grooves is disposed on the peripheral surface of the shaft so that pins (engagement sections) of the regulation members are fit (engaged) in the grooves for positioning. A group of grooves are arranged in the axis direction of the shaft so as to correspond to different sizes (widths) of the paper roll to be used.

The regulation members are mounted on the shaft at different mounting positions in the axis direction by changing fitting positions of the regulation members to the grooves of the shaft. Accordingly, regardless of different sizes (widths) of the paper roll to be replaced, the movement of the paper roll in the axis direction is regulated by changing positions of the regulation members.

In the above reel for paper roll, the regulation members are positioned by using the grooves formed on the shaft. As a consequence, there is a risk that the grooves used for positioning of the regulation members which correspond to the paper rolls to be replaced having sizes (widths) significantly close to each other overlap with each other. Accordingly, the grooves for the paper roll having close sizes need to be formed on different shafts, which leads to a problem in that additional shaft needs to be provided for replacement, thereby increasing the number of components.

### SUMMARY

An advantage of some aspects of the invention is that the roll medium supporting device that is capable of positioning and supporting a plurality of roll media having widths close to each other without replacing a shaft member, and a recording apparatus having the same is provided.

Means for solving the above problem and the operational advantage of the invention will be described below. According to an aspect of the invention, a roll medium supporting device includes a shaft member that is inserted into a roll medium along an axis of the roll medium which is made of a medium wound into a roll; and a supporting member that includes an insertion hole that allows the shaft member to be inserted and an engagement section that is engageable with the shaft member, the supporting member being configured to support the roll medium in an axis direction of the shaft member, wherein the shaft member includes, in a state that the shaft member is inserted into the insertion hole, a first positioning section that positions the supporting member in the axis direction by engaging the engagement section, and a second positioning section that positions the supporting member in the axis direction by engaging the engagement section at a position different from the first positioning section both in the axis direction and in a circumferential direction of the shaft member.

With this configuration, the first positioning section and the second positioning section on the shaft member are disposed at different positions both in the axis direction and in the circumferential direction of the shaft member. Accordingly, in spite of the positions being close in the axis direction, the first positioning section and the second positioning section do not overlap with each other. As a result, positioning of the supporting member at the first positioning section and the second positioning section can be selectively performed by selectively engaging the engagement section of the supporting member with the first positioning section and the second positioning section. Therefore, it is possible to position and support a plurality of roll media having widths close to each other without replacing the shaft member.

In the above roll medium supporting device, it is preferable that the insertion hole includes a first hole engagement section and a second hole engagement section, and the shaft member includes a shaft engagement section such that, when the shaft member is inserted into the insertion hole at a first angle in a rotation direction about an axis of the shaft member, the shaft member engages the first hole engagement section in the rotation direction, and, when the shaft member is inserted into the insertion hole at a second angle in a rotation direction about the axis of the shaft member, the shaft member engages the second hole engagement section in the rotation direction.

With this configuration, it is possible to position the shaft member in the rotation direction by inserting the shaft member into the insertion hole at different positional aspects in the rotation direction about the axis of the shaft member. In the above roll medium supporting device, it is preferable that the shaft member has a cross section in a polygonal shape, and the shape of the insertion hole is a polygonal shape which is the same as the cross section of the shaft member.

With this configuration, when the shaft member is rotated, the rotation force of the shaft member can be effectively transmitted to the supporting member. In the above roll medium supporting device, it is preferable that the shaft member has a cross section in a square, the first positioning sections are arranged in pair with each one of the pair being provided on each of two side faces of four side faces of the shaft member which oppose with respect to the axis of the shaft member, the second positioning sections are arranged in pair with each one of the pair being provided on each of remaining two side faces which oppose with respect to the axis of the shaft member, and the engagement sections are disposed on each of four side walls that forms the insertion hole which is formed in a square.

With this configuration, the shaft member can be inserted into the insertion hole regardless of the position in the rotation direction about the axis of the shaft member. Therefore, the shaft member can be easily assembled to the supporting member.

According to another aspect of the invention, a recording apparatus includes the roll medium supporting device having the above configuration, and a recording section that performs recording operation on the medium fed from the roll medium supporting device. With this configuration, it is possible to obtain the same operational advantage as that of the roll medium supporting device.

### BRIEF DESCRIPTION OF THE DRAWINGS

The invention will be described with reference to the accompanying drawings, wherein like numbers reference like elements.

FIG. 1 is a perspective view of an ink jet printer according to one embodiment.

FIG. 2 is a perspective view of the printer showing that a drawer member is drawn out.

FIG. 3 is a schematic sectional view of the printer.

FIG. 4 is a front view of a roll paper supporting device of the printer.

FIG. 5 is an enlarged perspective view of an essential part of a flange of the roll paper supporting device.

FIG. 6 is a perspective view of a shaft member of the roll paper supporting device.

FIG. 7 is a side view of the roll paper supporting device.

FIG. 8 is an enlarged perspective view of an essential part of the roll paper supporting device.

FIG. 9 is an enlarged schematic view of an essential part of the roll paper supporting device according to a modified example.

FIG. 10 is an enlarged schematic view of an essential part of the roll paper supporting device according to another modified example.

### DESCRIPTION OF EXEMPLARY EMBODIMENTS

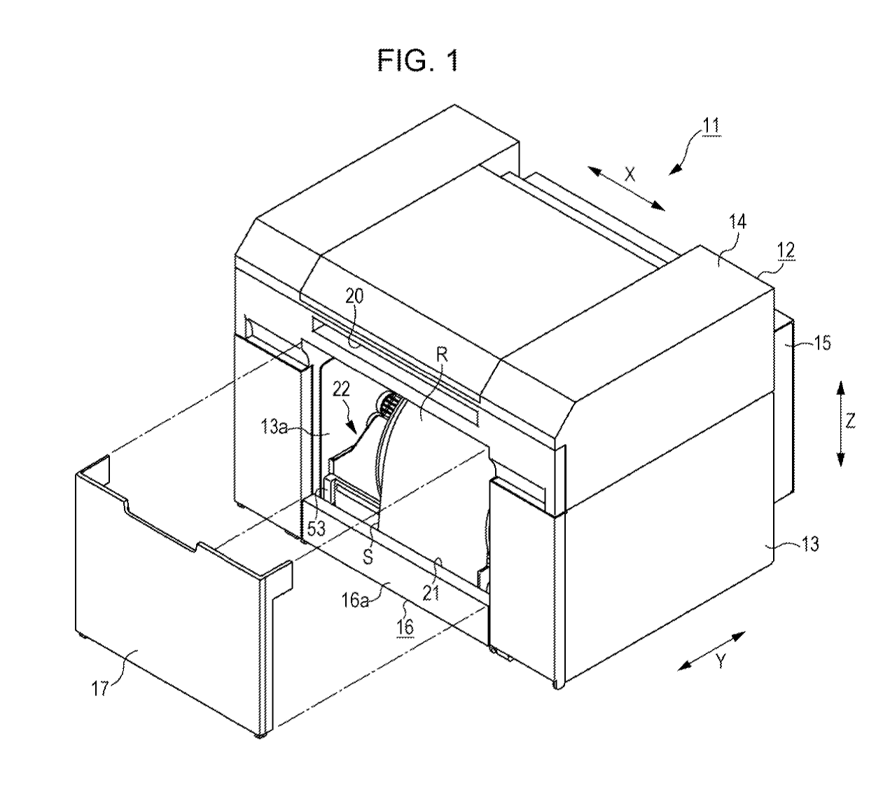

An embodiment in which a recording apparatus is implemented as an ink jet printer will be described below with reference to the drawings. As shown in FIG. 1, an ink jet printer 11 which is an example of recording apparatus includes an apparatus body 12 formed in a substantially rectangular box shape. The apparatus body 12 includes a first housing unit 13, a second housing unit 14 disposed on the upper side of the first housing unit 13, and a third housing unit 15 disposed on the rear side of the first housing unit 13. In this embodiment, a direction in which the second housing unit 14 and the third housing unit 15 are arranged is defined as a front-back direction Y, which is perpendicular to an up-down direction Z that extends in the gravitational direction. Further, a longitudinal direction of the first housing unit 13 and the second housing unit 14 which is perpendicular to both the up-down direction Z and the front-back direction Y is defined as a width direction X.

A housing chamber 13a is disposed in the first housing unit 13 of the apparatus body 12 at the center portion in the width direction X. A drawer member 16 is drawably housed in the housing chamber 13a. The drawer member 16 has a front plate 16a which is formed in an elongated rectangular shape that extends in the width direction X and is disposed on the lower front face. When the drawer member 16 is in a housed position (as shown in FIG. 1) in which the drawer member 16 is housed in the apparatus body 12 (housing chamber 13a), the front plate 16a is exposed on the front face of the first housing unit 13.

The drawer member 16 is configured to house a roll paper R as an example of roll medium which is made of a paper sheet S as an example of elongated medium wound into a roll. An insertion port 21 is open on the back side of the front plate 16a of the drawer member 16 so that the paper sheet S unwound from the roll paper R which is housed in the drawer member 16 is inserted through the insertion port 21.

A front cover 17 formed in a substantially rectangular plate shape is detachably mounted on the upper side of the front plate 16a of the first housing unit 13. Further, a paper exit port 20 is disposed on the front face of the second housing unit 14 at a position above the housing chamber 13a.

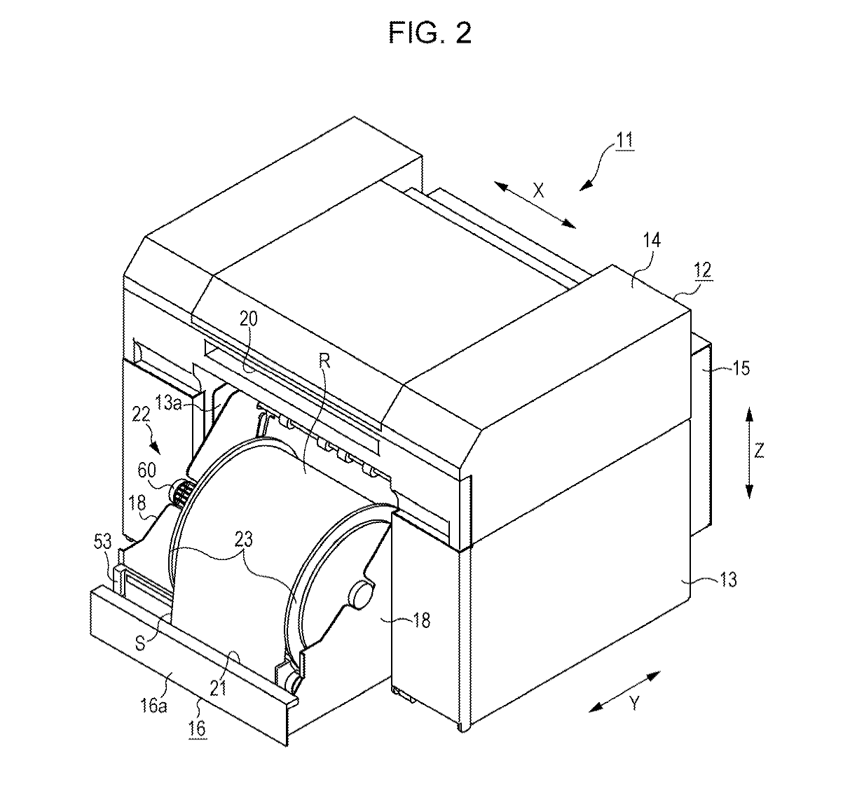

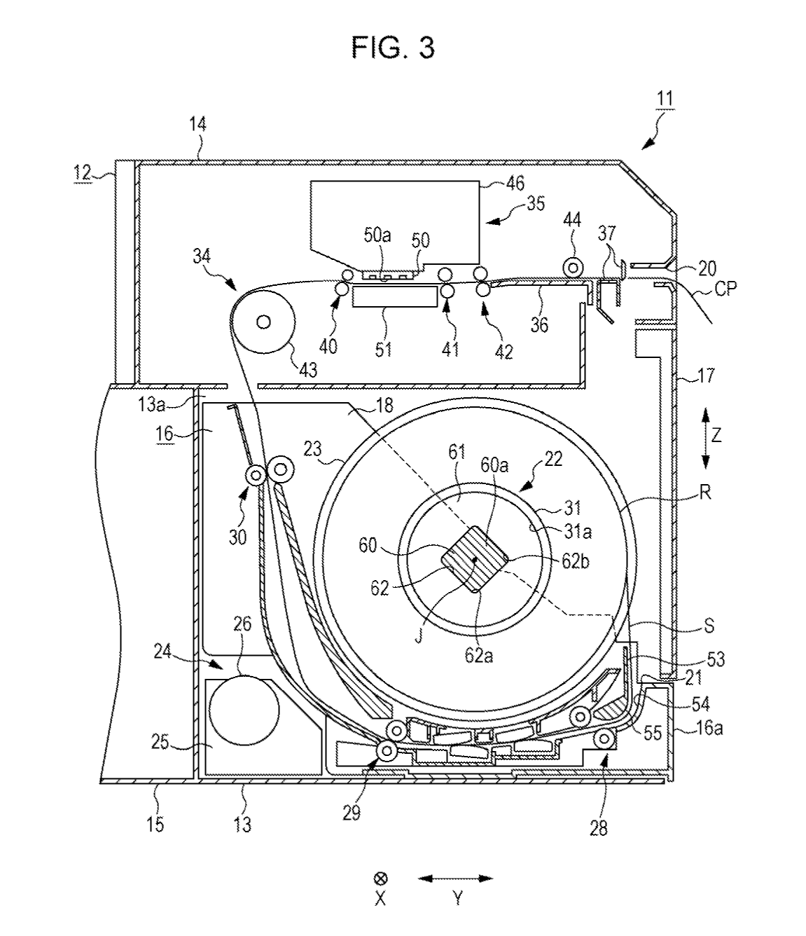

As shown in FIGS. 2 and 3, the drawer member 16 has a pair of side plates 18 on each side of the drawer member 16 in the width direction X. The front ends of the respective side plates 18 are connected to the right and left ends of the front plate 16a.

The drawer member 16 supports the roll paper supporting device 22 as an example of roll medium supporting device that supports the roll paper R in a rotatable manner. To set the roll paper R in the apparatus body 12, the drawer member 16 which is in the housed position (as shown in FIG. 1) is drawn out forward from the housing chamber 13a to a drawn out position (as shown in FIG. 2).

Then, the roll paper R is mounted on the roll paper supporting device 22. After the roll paper supporting device 22 on which the roll paper R is mounted is supported on the drawer member 16, the leading end of the paper sheet S unwound from the roll paper R is inserted through the insertion port 21. After that, the drawer member 16 is pushed from the drawn out position to the housed position in the housing chamber 13a. This completes setting of the roll paper R in the apparatus body 12.

As shown in FIG. 3, a fixation frame 25 is disposed at the bottom of the housing chamber 13a on the back side of the drawer member 16. A transportation device 24 for transporting (feeding) the paper sheet S unwound from the roll paper R to the second housing unit 14 is disposed at one end of the fixation frame 25 and the drawer member 16 in the width direction X.

The transportation device 24 transports the paper sheet S downstream along a transportation path which is formed in the drawer member 16. Further, a motor 26 which serves as a drive source of the transportation device 24 and the roll paper supporting device 22 is fixedly provided on the fixation frame 25.

The second housing unit 14 houses a transportation mechanism 34 that transports the paper sheet S to the paper exit port 20, a recording section 35 that performs printing (recording operation) with ink on the paper sheet S transported by the transportation device 24 and the transportation mechanism 34, a heater 36 that dries the paper sheet S on which ink is applied, and a cutter 37 that cuts the dried paper sheet S.

The transportation mechanism 34 includes pairs of transportation rollers 30, 40, 41, 42, an intermediate roller 43, and a paper exit roller 44. The pair of transportation rollers 30 is disposed on the drawer member 16.

The recording section 35 includes a carriage 46 that is movable in a reciprocating manner in the width direction X and a recording head 50 that is supported on the lower portion of the carriage 46. A plurality of nozzles 50a that ejects ink as an example of liquid is open on the underside of the recording head 50.

Further, a support table 51 for supporting the transported paper sheet S is disposed under the carriage 46 between the pair of transportation rollers 40 and the pair of transportation rollers 41 which are arranged along the transportation path of the paper sheet S.

The paper sheet S fed out from the drawer member 16 is transported by the transportation device 24 and the transportation mechanism 34 along the transportation path. During transportation of the paper sheet S by the transportation mechanism 34, printing is performed on the paper sheet S by ejecting ink from the recording head 50 that moves with the carriage 46 in the width direction X.

The printed paper sheet S is dried while being transported along the top surface of the heater 36 in a planar shape. After the dried paper sheet S passed the heater 36, the printed part of the paper sheet S is cut by a cutter 37 per unit length into cut sheets CP. The cut sheets CP are ejected through the paper exit port 20 to the outside of the apparatus body 12.

As shown in FIG. 3, the drawer member 16 has a path forming member 53 that forms the insertion port 21 between the drawer member 16 and the front plate 16a. The path forming member 53 has a path forming section 55 curved in a projecting shape that guides the paper sheet S unwound from the roll paper R. The front plate 16a has a path forming section 54 curved in a recessed shape that opposes the path forming section 55 and guides the paper sheet S. The path forming sections 54, 55 are fixedly provided downstream to the roll paper supporting device 22 in the transportation path of the paper sheet S.

Pairs of transportation rollers 28, 29 that transport the paper sheet S along the transportation path are disposed with a specific distance therebetween at positions downstream to the path forming sections 54, 55 in the transportation path of the paper sheet S. When the pairs of transportation rollers 28, 29 are rotated by a driving force of the motor 26, the pairs of transportation rollers 28, 29 transport the paper sheet S along the transportation path.

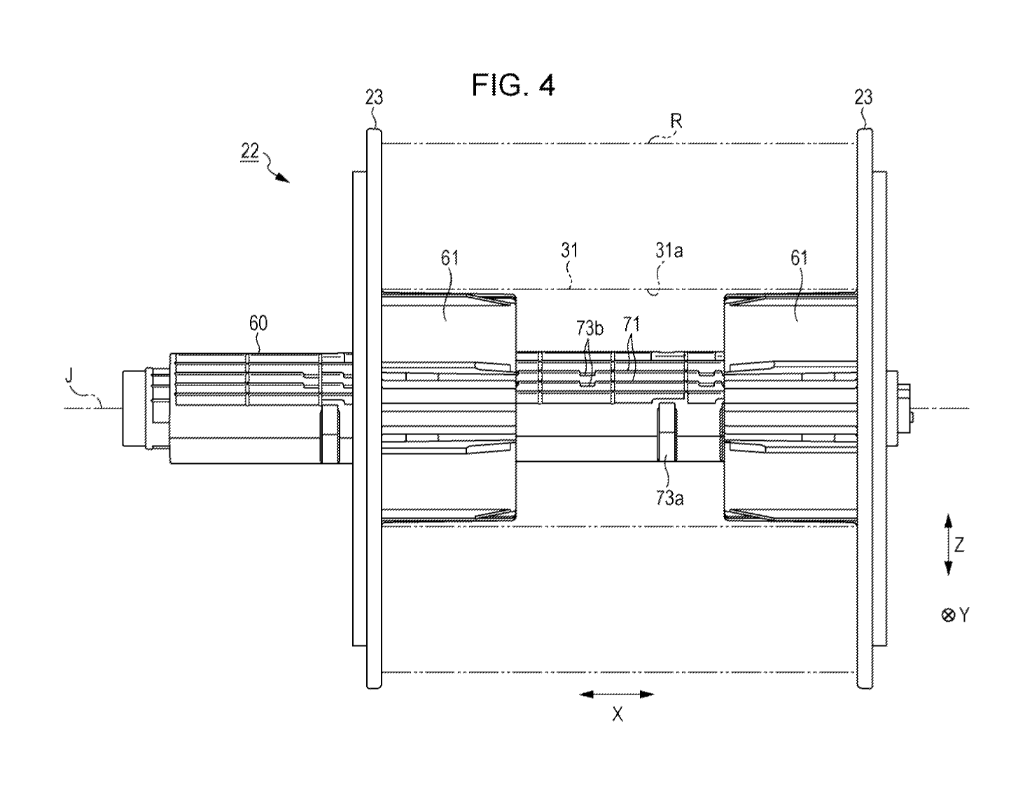

Next, a configuration of the roll paper supporting device 22 will be described in detail. As shown in FIGS. 3 and 4, the roll paper supporting device 22 includes a shaft member 60 having a cross section in a square shape that is inserted into a center hole 31a of a cylindrical core member 31 of the roll paper R, and a pair of flanges 23 formed in a substantially disk shape as an example of supporting member that is mounted on the shaft member 60 so as to hold the roll paper R from the right and left sides and support the roll paper R with the shaft member 60 being inserted into the center hole 31a.

Inserting portions 61 in a substantially cylindrical shape are disposed at the center portion on the inner side of the respective flanges 23 so as to protrude inward in the width direction X (to the side of the roll paper R). When the roll paper R is supported by the flanges 23, the inserting portions 61 are inserted into the center hole 31a of the core member 31 of the roll paper R.

Insertion holes 62 in a square shape are disposed at the center of the respective inserting portions 61 and extend along an axis J of the shaft member 60 so that the shaft member 60 can be inserted into the insertion holes 62. Accordingly, the shape of the insertion hole 62 is the same as the cross sectional shape of the shaft member 60. The axis J of the shaft member 60 also serves as the axis of the roll paper R.

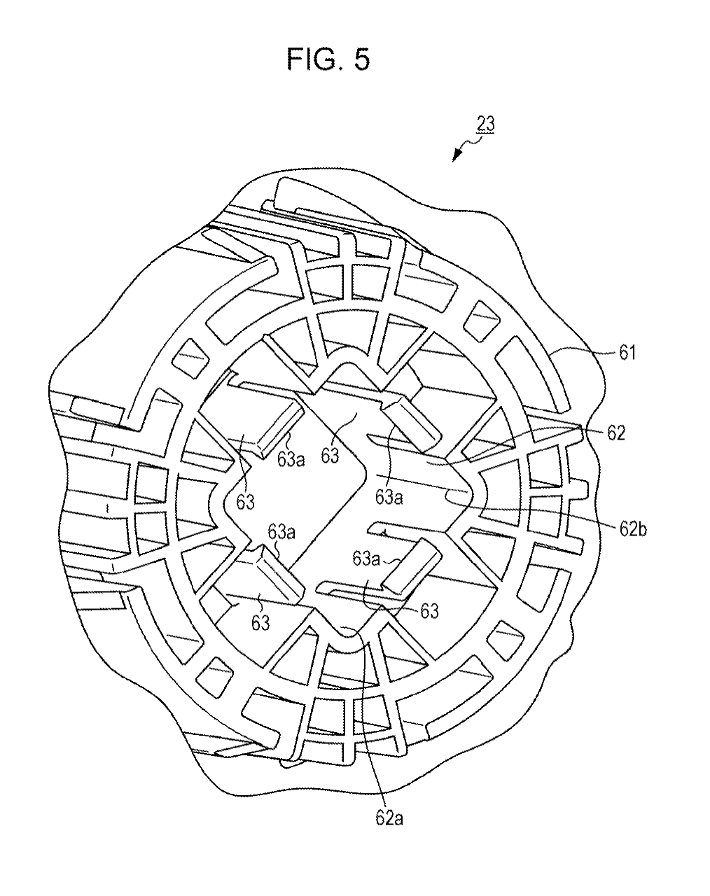

As shown in FIGS. 3 and 5, two adjacent corners of four corners on the circumference of the insertion hole 62 are provided as a first hole engagement section 62a and a second hole engagement section 62b. Engagement sections 63 in a rectangular plate shape are formed by notching four side walls of the insertion hole 62 so that the engagement sections 63 engage the shaft member 60 when the shaft member 60 is inserted into the insertion hole 62. The engagement sections 63 are resiliently deformable in a radial direction of the flange 23. Engagement claws 63a that extend inward are each disposed at the distal end of the engagement sections 63.

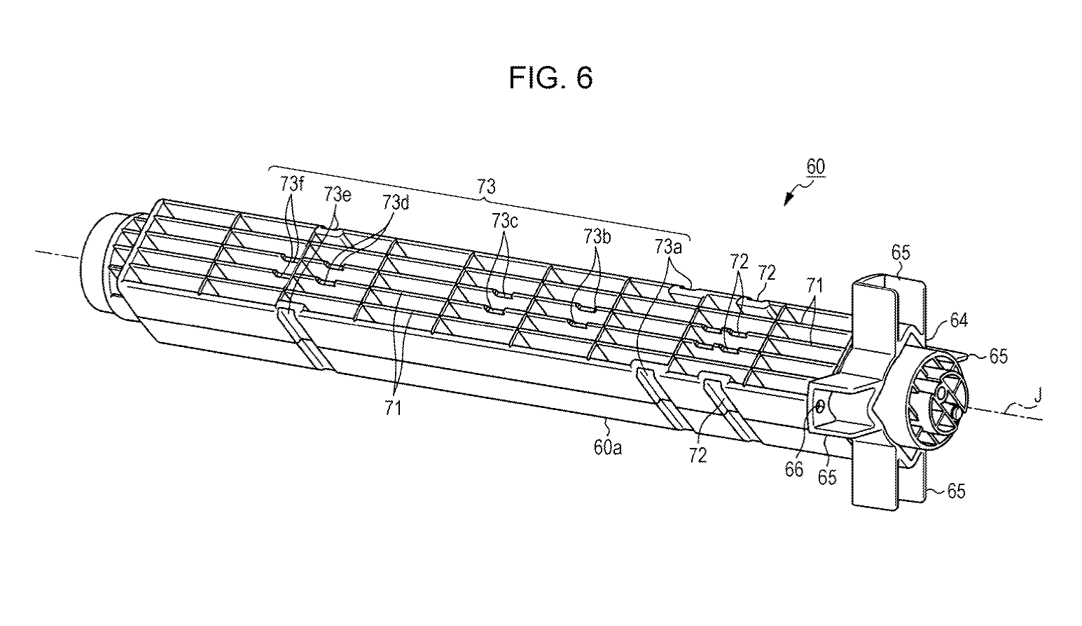

As shown in FIGS. 3 and 6, a connection section 64 in a cross shape for connecting to one of the two flanges 23 is disposed at one end of the shaft member 60 which is inserted along the axis J of the roll paper R. The connection section 64 has four extending portions 65 that radially extend and are equally spaced from each other in the circumferential direction. Screw holes 66 are disposed on two of the four extending portions 65 which oppose with respect to the axis J.

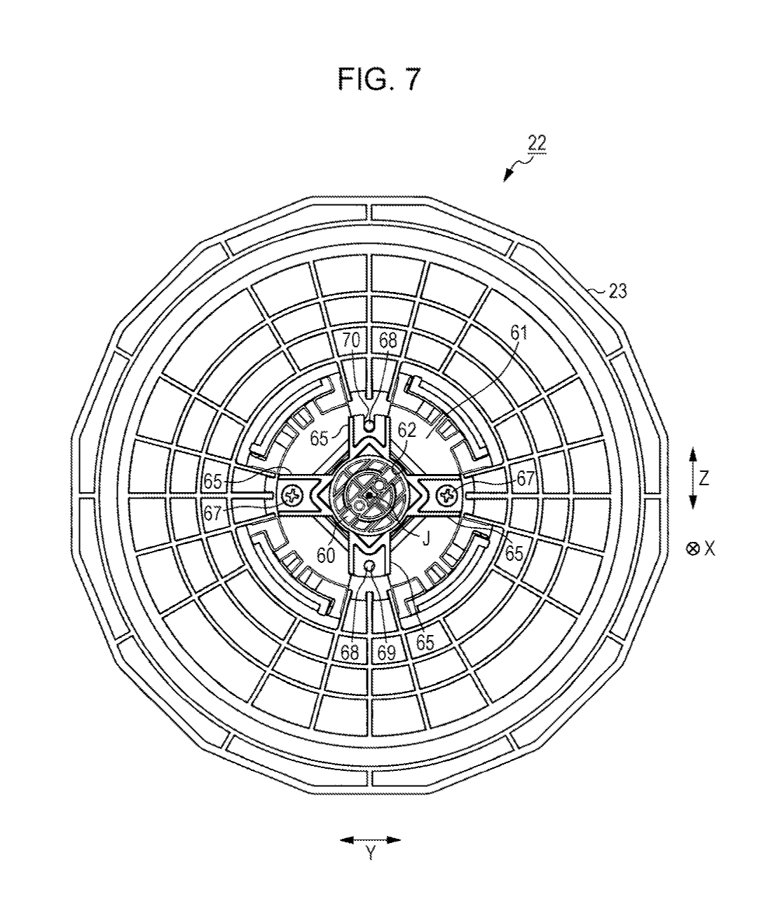

As shown in FIGS. 6 and 7, the shaft member 60 are connected to the flange 23 when the respective extending portions 65 are secured on the flange 23 by using screws 67 in the state that the shaft member 60 is inserted into the insertion hole 62 of the flange 23. Further, engagement holes 69 and engagement notches 70 that engage two projections 68 formed on the outer side of the flange 23 are disposed on two of the four projections 65 which oppose with respect to the axis J and do not have the screw hole 66.

As shown in FIG. 3, one of the four corners on the circumference of the shaft member 60 is defines as a shaft engagement section 60a. When the shaft member 60 is inserted into the insertion hole 62 at a first angle in a rotation direction about the axis J of the shaft member 60, the shaft engagement section 60a engages the first hole engagement section 62a in the rotation direction. Further, when the shaft member 60 is inserted into the insertion hole 62 at a second angle (in this embodiment, an angle displaced from the first angle by 90 degrees) in a rotation direction about the axis J of the shaft member 60, the shaft engagement section 60a engages the second hole engagement section 62b in the rotation direction.

As shown in FIGS. 5 and 6, a plurality of ribs 71 are generally disposed on two of the four side faces of the shaft member 60 which oppose with respect to the axis J of the shaft member 60. Fixed-side engagement grooves 72 are disposed on the side faces of the shaft member 60 in the vicinity of the connection section 64 so that the engagement claws 63a of the engagement sections 63 on one of the flanges 23 which is fixed to the connection section 64 (hereinafter, referred to as “fixed-side flange 23”) engage the fixed-side engagement grooves 72. The respective fixed-side engagement grooves 72 extend in a direction perpendicular to the axis J.

Further, movable-side engagement grooves 73 are disposed on the shaft member 60 so that the engagement claws 63a of the engagement sections 63 on one of the flanges 23 which is not fixed to the connection section 64 (hereinafter, referred to as “movable-side flange 23”) engage the movable-side engagement grooves 72 depending on the size of the roll paper R to be supported.

A plurality of pairs (in this embodiment, six pairs) of the movable-side engagement grooves 73 are disposed on the shaft member 60 apart from each other by an appropriate distance in the axis direction (the direction in which the axis J extends). The movable-side engagement grooves 73 of the respective pairs are disposed on two of the four side faces of the shaft member 60 which oppose with respect to the axis J. The respective movable-side engagement grooves 73 extend in a direction perpendicular to the axis J.

The six pairs of the movable-side engagement grooves 73 are defined, in the order of increasing width of the roll paper R to be supported, as first engagement grooves 73a for 3.5 inch width, second engagement grooves 73b for 4 inch width, third engagement grooves 73c for 6 inch width, fourth engagement grooves 73d for 8 inch width, fifth engagement grooves 73e for A4 width, and sixth engagement grooves 73f for 8.5 inch width. Accordingly, the engagement claws 63a of the engagement sections 63 on the movable-side flange 23 engage any of the engagement grooves 73a to 73f depending on the size of the width of the roll paper R supported by the flanges 23.

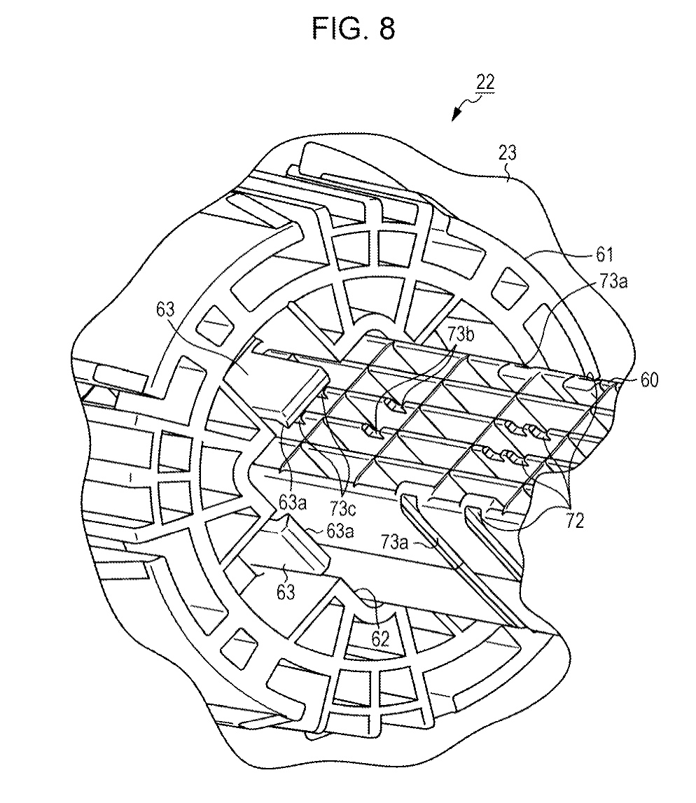

For example, FIG. 8 shows the position of the movable-side flange 23 when supporting the roll paper R of 6 inch width. In this case, two of the four engagement claws 63a of the engagement sections 63 on the movable-side flange 23 which correspond to the third engagement grooves 73c engage the third engagement grooves 73c, while the remaining two of the four engagement claws 63a of the engagement sections 63 which do not correspond to the third engagement grooves 73c abut against the side faces of the shaft member 60.

Further, the sizes of the roll paper R of 8 inch width (203 mm width), 8.5 inch width (216 mm width) and A4 width (210 mm width) are significantly close to each other. Accordingly, as shown in FIG. 6, the fourth engagement grooves 73d for 8 inch width, the sixth engagement grooves 73f for 8.5 inch width and the fifth engagement grooves 73e for A4 width of the engagement grooves 73a to 73f which correspond to the above three widths of the roll paper R are disposed on different side faces of the shaft member 60.

That is, the fourth engagement grooves 73d and the sixth engagement grooves 73f are disposed on the same two side faces of the four side faces of the shaft member 60, while the fifth engagement grooves 73e are disposed on two side faces of the four side faces of the shaft member 60 which are different from the two side faces on which the fourth engagement grooves 73d and the sixth engagement grooves 73f are disposed.

Accordingly, in the state that the shaft member 60 is inserted into the insertion hole 62 of the movable-side flange 23, the fourth engagement grooves 73d, the sixth engagement grooves 73f and the fifth engagement grooves 73e engage the engagement claws 63a of the engagement sections 63 on the movable-side flange 23 at different positions on the shaft member 60 both in the axis direction and the circumferential direction and position the movable-side flange 23 in the axis direction.

That is, when the movable-side flange 23 is positioned by using the fourth engagement grooves 73d and the sixth engagement grooves 73f, the respective engagement grooves 73d, 73f engage the respective engagement claws 63a of the engagement sections 63. On the other hand, when the movable-side flange 23 is positioned by using the fifth engagement grooves 73e, the fifth engagement grooves 73e engage the respective engagement claws 63a of the engagement sections 63.

In this embodiment, a first positioning section for positioning the movable-side flange 23 in the axis direction of the shaft member 60 is formed by the fourth engagement grooves 73d and the sixth engagement grooves 73f, while a second positioning section for positioning the movable-side flange 23 in the axis direction of the shaft member 60 is formed by the fifth engagement grooves 73e.

Next, an operation of the ink jet printer 11 having the above configuration will be described, focusing on an operation of the roll paper supporting device during mounting of the roll paper R. When printing is performed on the paper sheet S, the drawer member 16 is drawn out from the housed position (as shown in FIG. 1) to the drawn out position (as shown in FIG. 2) of the drawer member 16. Then, the shaft member 60 of the roll paper supporting device 22 in the state that the movable-side flange 23 is removed is inserted into the center hole 31a of the core member 31 of the roll paper R, and the inserting portion 61 on the fixed-side flange 23 is inserted into the center hole 31a.

Then, the shaft member 60 is inserted into the insertion hole 62 of the movable-side flange 23, and the inserting portion 61 on the movable-side flange 23 is inserted into the center hole 31a from the opposite side of the fixed-side flange 23. At this point, the engagement claws 63a of the engagement sections 63 on the movable-side flange 23 engage the movable-side engagement grooves 73 which correspond to the width of the roll paper R to be used. Then, a user is noticed that the movable-side flange 23 is positioned at a normal position, and the mounting of the roll paper R on the roll paper supporting device is completed.

Next, the roll paper supporting device 22 on which the roll paper R is mounted is supported on the drawer member 16, and the leading end of the paper sheet S unwound from the roll paper R is inserted through the insertion port 21. After that, the drawer member 16 is pushed from the drawn out position to the housed position in the housing chamber 13a. The paper sheet S fed out from the roll paper R in the drawer member 16 is transported by the transportation device 24 and the transportation mechanism 34 along the transportation path.

During transportation of the paper sheet S by the transportation mechanism 34, printing is performed on the paper sheet S by ejecting ink from the recording head 50 that moves with the carriage 46 in the width direction X. The printed paper sheet S is dried by the heater 36, and then cut by the cutter 37 into cut sheets CP. The cut sheets CP are ejected through the paper exit port 20 to the outside of the apparatus body 12.

When changing of the width of the paper sheet S to be printed is desired, the drawer member 16 is drawn out from the housed position to the drawn out position. Then, the roll paper R is replaced with the roll paper R of a desired width, and the drawer member 16 is pushed from the drawn out position to the housed position. After that, printing is performed on the paper sheet S in the same manner as described above.

The sizes of the roll paper R of 8 inch width (203 mm width), 8.5 inch width (216 mm width) and A4 width (210 mm width) are significantly close to each other. As a consequence, providing the fourth engagement grooves 73d for 8 inch width, the sixth engagement grooves 73f for 8.5 inch width and the fifth engagement grooves 73e for A4 width which correspond to the above three widths of the roll paper R on the same side faces of the shaft member 60 leads to a risk that the fifth engagement grooves 73e overlap the fourth engagement grooves 73d and the sixth engagement grooves 73f.

In order to avoid that risk, two shaft members 60 need to be provided, that is, the shaft member 60 on which the fifth engagement grooves 73e and the sixth engagement grooves 73f are disposed and the fourth engagement grooves 73d are not disposed, and the shaft member 60 on which the fifth engagement grooves 73e and the sixth engagement grooves 73f are not disposed and the fourth engagement grooves 73d are disposed. This leads to a problem in that the number of components increases.

In this embodiment, the side faces on which the fourth engagement grooves 73d for 8 inch width and the sixth engagement grooves 73f for 8.5 inch width are disposed are different from the side faces on which the fifth engagement grooves 73e for A4 width are disposed. Accordingly, it is possible to correspond to the roll papers R of 8 inch width, 8.5 inch width and A4 width with a single shaft member 60.

The following effect can be achieved according to the above embodiment which is described in detail: (1) In the roll paper supporting device 22, the side faces on which the fourth engagement grooves 73d for 8 inch width and the sixth engagement grooves 73f for 8.5 inch width are disposed are different from the side faces on which the fifth engagement grooves 73e for A4 width are disposed. Accordingly, in spite of the positions of those engagement grooves being close in the axis direction, the engagement grooves do not overlap with each other. As a result, positioning of the movable-side flange 23 can be performed at the engagement grooves 73d to 73f by selectively engaging the engagement claws 63a of the engagement sections 63 on the movable-side flange 23 with the engagement grooves 73d to 73f. Therefore, it is possible to position and support a plurality of roll papers R having widths close to each other without replacing the shaft member 60.

(2) In the roll paper supporting device 22, the insertion hole 62 of the flange 23 has the first hole engagement section 62a and the second hole engagement section 62b. Further, the shaft member 60 has the shaft engagement section 60a such that, when the shaft member 60 is inserted into the insertion hole 62 at the first angle in the rotation direction about the axis J, the shaft member engages the first hole engagement section 62a in the rotation direction, and, when the shaft member 60 is inserted into the insertion hole 62 at the second angle in the rotation direction about the axis J, the shaft member engages the second hole engagement section 62b in the rotation direction. Accordingly, it is possible to position the shaft member 60 in the rotation direction by inserting the shaft member 60 into the insertion hole 62 at different positional aspects in the rotation direction about the axis J of the shaft member 60.

(3) In the roll paper supporting device 22, the cross sectional shape of the shaft member 60 is a polygonal shape (square), and the shape of the insertion hole 62 is a polygonal shape (square) which is the same as the cross sectional shape of the shaft member 60. Accordingly, when the shaft member 60 is rotated, the rotation force of the shaft member 60 can be effectively transmitted to the flange 23. The same shape means that they are the same in shape but not in size.

(4) In the roll paper supporting device 22, the shaft member 60 has a cross section in a square. The pairs of the fourth engagement grooves 73d and the sixth engagement grooves 73f are arranged such that each one of the pair is provided on each of the two side faces of the four side faces of the shaft member 60 which oppose with respect to the axis J, while the pairs of the fifth engagement grooves 73e are arranged such that each one of the pair is provided on each of the remaining two side faces which oppose with respect to the axis J. Further, the engagement sections 63 are formed on each of the four side walls of the insertion hole 62 which is formed in a square. Accordingly, the shaft member 60 can be inserted into the insertion hole 62 regardless of the position in the rotation direction about the axis J. Therefore, the shaft member 60 can be easily assembled to the flange 23.

### Modified Examples

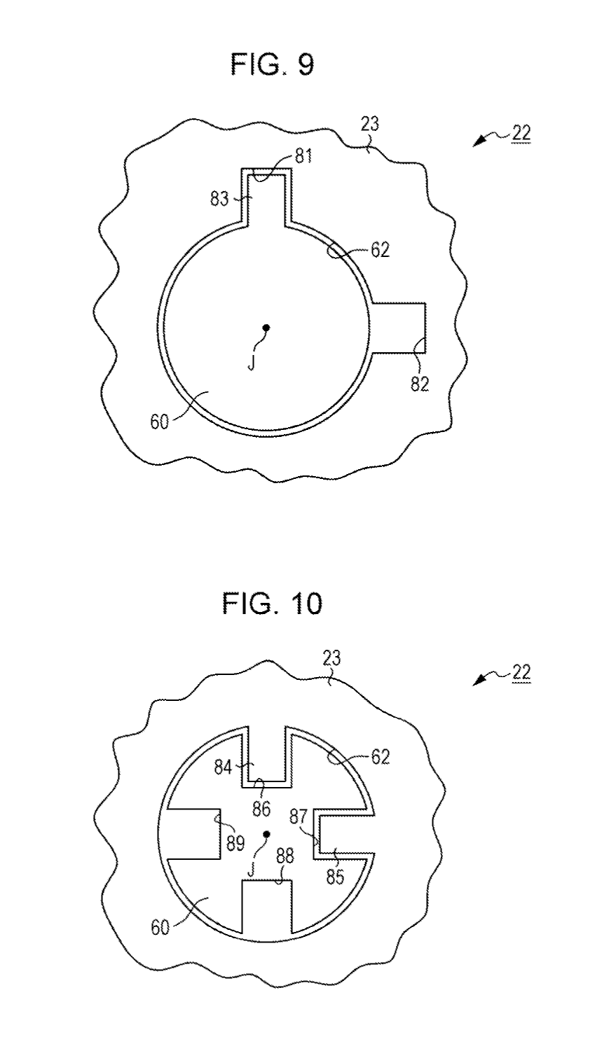

Moreover, the following modifications can be made to the above described embodiment. As shown in FIG. 9, in the roll paper supporting device 22, the shape of the insertion hole 62 and the cross sectional shape of the shaft member 60 are circular. A first hole recess 81 and a second hole recess 82 are disposed as the first hole engagement section 62a and the second hole engagement section 62b, respectively, on the inner peripheral surface of the insertion hole 62 at two positions apart from each other by 90 degrees about the axis J. Further, the ridge 83 that is insertable into the first hole recess 81 and the second hole recess 82 may be disposed as a shaft engagement section which extends in the longitudinal direction on the peripheral surface of the shaft member 60. Accordingly, it is possible to position the shaft member 60 in the rotation direction by inserting the shaft member 60 into the insertion hole 62 at different positional aspects in the rotation direction about the axis J of the shaft member 60.

As shown in FIG. 10, in the roll paper supporting device 22, the shape of the insertion hole 62 and the cross sectional shape of the shaft member 60 are circular. A first hole protrusion 84 and a second hole protrusion 85 are disposed as the first hole engagement section and the second hole engagement section, respectively, on the inner peripheral surface of the insertion hole 62 at two positions apart from each other by 90 degrees about the axis J. Further, four recesses 86, 87, 88, 89 that are insertable by the first hole protrusion 84 and the second hole protrusion 85 may be disposed as shaft engagement sections which are equally spaced from each other in the circumferential direction on the peripheral surface of the shaft member 60. Accordingly, it is possible to position the shaft member 60 in the rotation direction by inserting the shaft member 60 into the insertion hole 62 at different positional aspects in the rotation direction about the axis J of the shaft member 60.

The cross sectional shape of the shaft member 60 may be a rectangle. In this case, the shape of the insertion hole 62 of the flange 23 may be cross shape formed of rectangles crossing at 90 degrees. Further, the shape or strength of the engagement claws 63a that engage the movable-side engagement grooves 73 may be modified to change the feeling felt by the user during engagement of the engagement claws 63a so that the user can recognize especially whether the engagement claws 63a engages either the fourth engagement grooves 73d for 8 inch width and the sixth engagement grooves 73f for 8.5 inch width or the fifth engagement grooves 73e for A4 width.

The cross sectional shape of the shaft member 60 is not limited to a rectangular shape, but may be any polygonal shape such as triangle, pentagon, hexagon, octagon, or circular or oblong shape. In this case, the shape of the insertion hole 62 is the same as the cross sectional shape of the shaft member 60.

Each of the engagement grooves 73a to 73f on the shaft member 60 may be a single engagement groove. The number of engagement sections 63 on the insertion hole 62 of the flange 23 may be one, two or three.

The engagement section 63 may be configured as a recess, and the engagement grooves 73a to 73f on the shaft member 60 may be modified as a protrusion that is engageable with the corresponding recess. The roll medium may be, for example, cloth, plastic film and metal foil.

The ink jet printer 11 may be a line printer. In the above embodiment, the recording apparatus may be a fluid ejecting apparatus that performs recording by ejecting or dispensing a fluid other than ink (such as a liquid, a liquid material containing particles of functional material dispersed or mixed in a liquid, and a fluid material such as a gel (including a solid which can be flowed and ejected as a fluid)). For example, a liquid ejection apparatus that performs recording by ejecting a liquid material containing materials such as electrode material and color material (pixel material) in a dispersed or dissolved state, which are used for manufacturing liquid crystal displays, electroluminescence (EL) displays, surface emitting displays and the like may be used. Further, a fluid material ejecting apparatus that ejects a fluid material such as a gel (for example, a physical gel), and a particulate material ejecting apparatus (for example, a toner jet recording apparatus) that ejects a solid, for example, particulates such as toner (particulate material) may also be used. The invention may be applied to any one of the above-mentioned liquid ejecting apparatuses. The term “fluid” as used herein does not include a fluid made of a gas only, and includes a liquid (such as inorganic solvent, organic solvent, liquid solution, liquid resin and liquid metal (molten metal)), a liquid material, a fluid material, a particulate material and the like.

The roll medium supporting apparatus is not limited to be included in a recording apparatus that performs recording operation on a roll medium, but also may be included in a variety of operation apparatuses that perform any operation on a roll medium.

The entire disclosure of Japanese Patent Application No. 2012-284511, filed Dec. 27, 2012 is expressly incorporated by reference herein.

What is claimed is:

1. A roll medium supporting device comprising:
a shaft member that is inserted into a roll medium along an axis of the roll medium which is made of a medium wound into a roll; and
a supporting member that includes an insertion hole that allows the shaft member to be inserted and an engagement section that is engageable with the shaft member, the supporting member being configured to support the roll medium in an axis direction of the shaft member,
wherein the shaft member includes, in a state that the shaft member is inserted into the insertion hole, a first positioning section that positions the supporting member in an axis direction by engaging the engagement section, and a second positioning section that positions the supporting member in the axis direction by engaging the engagement section at a position different from the first positioning section both in the axis direction and in a circumferential direction of the shaft member.

2. The roll medium supporting device according to claim 1, wherein the insertion hole includes a first hole engagement section and a second hole engagement section, and the shaft member includes a shaft engagement section such that, when the shaft member is inserted into the insertion hole at a first angle in a rotation direction about an axis of the shaft member, the shaft member engages the first hole engagement section in the rotation direction, and, when the shaft member is inserted into the insertion hole at a second angle in a rotation direction about the axis of the shaft member, the shaft member engages the second hole engagement section in the rotation direction.

3. The roll medium supporting device according to claim 2, wherein the shaft member has a cross section in a polygonal shape, and the shape of the insertion hole is a polygonal shape which is the same as the cross section of the shaft member.

4. The roll medium supporting device according to claim 3, wherein the shaft member has a cross section in a square, the first positioning sections are arranged in pair with each one of the pair being provided on each of two side faces of four side faces of the shaft member which oppose with respect to the axis of the shaft member, the second positioning sections are arranged in pair with each one of the pair being provided on each of remaining two side faces which oppose with respect to the axis of the shaft member, and the engagement sections are disposed on each of four side walls that forms the insertion hole which is formed in a square.

5. A recording apparatus comprising:
the roll medium supporting device according to claim 1; and
a recording section that performs recording operation on the medium fed from the roll medium supporting device.

6. A recording apparatus comprising:
the roll medium supporting device according to claim 2; and
a recording section that performs recording operation on the medium fed from the roll medium supporting device.

7. A recording apparatus comprising: the roll medium supporting device according to claim 3; and
a recording section that performs recording operation on the medium fed from the roll medium supporting device.

8. A recording apparatus comprising: the roll medium supporting device according to claim 4; and
a recording section that performs recording operation on the medium fed from the roll medium supporting device.
